(19) United States
(12) Patent Application Publication
(10) Pub. No.: US 2003/0211324 A1
(43) Pub. Date: Nov. 13, 2003

(54) Ornamental tooth decorations and methods for forming the same

(76) Inventor: Joseph Michael Brinkman, Fort Meyers Beach, FL (US)

Correspondence Address: SUGHRUE MION, PLLC, 2100 Pennslyvania Avenue, NW, Washington, DC, 20037-3213, US

(21) Appl. No.: 10/142,829

(22) Filed: May 13, 2002

(51) Int. Cl. B32B 5/16; B32B 9/00

(52) U.S. Cl. 428/403; 428/407

(57) ABSTRACT

A tooth ornament and a method of forming a tooth ornament are provided. The tooth ornament includes a decorative portion and a plurality of layers of a clear, adhesive, non-filled, low viscosity, light-curing sealant/resin, which secure the decorative portion to a live or artificial tooth. The decorative portion includes a light reflective gemstone, precious and non-precious metal, or a decal. The method of forming the tooth ornament includes: forming a first droplet of a clear, adhesive, light-cured sealant/resin having a concavity on a smooth flat surface; placing a second droplet of the clear, adhesive, light-cured sealant/resin into the concavity; positioning a light reflective gemstone into the second droplet and the concavity; forming a plurality of layers of the clear, adhesive, light-cured sealant/resin on the light-cured first and second droplets and the gemstone.

### BACKGROUND OF THE INVENTION

1. Field of the Invention

The present invention relates generally to ornamental tooth decorations. More particularly, the present invention is directed to the encasement of gemstones and other ornamental tooth decorations into a clear material enabling the ornamentation to be clearly seen, and which can be non-invasively bonded to the exterior surface of a tooth and methods for forming the tooth ornaments.

2. Description of the Related Art

The conventional art of tooth ornamentation is invasive to the tooth. Normally the tooth is drilled to create a concavity in which to embed a tooth ornament. The tooth ornament is normally encased in a mounting of metal structure, which is generally a precious metal.

The art of tooth ornamentation has been used as an additional ornamentation to the body for the purpose of fashion, fad, trend or personal enjoyment. Ear piercing, body piercing, tattooing, nail decorating and ornamentation such as earrings, bracelets, necklaces have been popular for a considerable amount of time. Although tooth ornamentation has been popular for many years, live teeth have been at possible risk from drilling into the tooth to make the concavity for the tooth ornament.

### SUMMARY OF THE INVENTION

In an illustrative, non-limiting embodiment of the invention, an ornament for a tooth is provided, in which a decorative portion is encased by and adhesively secured by a clear sealant/resin portion. The tooth ornament can be non-invasively bonded to any live or artificial tooth for temporary ornamentation of the tooth. The tooth ornament will eventually be dislodged by normal use of the tooth or may be removed as desired by a dental professional. The length of time before the tooth ornament is dislodged naturally depends on the particular use of the tooth.

In another illustrative, non-limiting embodiment of the invention, an ornament for a tooth is provided, which includes first, second, and third layers of clear sealant/resin and a decorative portion. The first clear sealant/resin layer is adhesively formed on a clean, smooth flat surface and has a concavity. The second clear sealant/resin layer is adhesively formed in the concavity of the first clear sealant/resin layer. The decorative portion is adhesively formed on the second clear sealant/resin layer, and the third clear sealant/resin layer is adhesively formed over the decorative portion and the first and second clear sealant/resin layers, such that the sealant/resin layers form an encasement of the decorative portion.

In another illustrative, non-limiting embodiment of the invention, a method of forming a tooth ornament is provided. The method includes: placing a first droplet of a clear, adhesive, light-curing sealant/resin on a smooth flat surface; light-curing the first droplet; drilling the light-cured first droplet with a milling tool to form a concavity in the light-cured first droplet; placing a second droplet of the clear, adhesive, light-curing sealant/resin into the concavity; positioning a gemstone into the second droplet and the concavity; light-curing the second droplet, after the gemstone is positioned; forming a plurality of layers of the clear, adhesive, light-curing sealant/resin on the light-cured first and second droplets and the gemstone; and light-curing each of the plurality of layers, after each of the plurality of layers is formed.

In another illustrative, non-limiting embodiment of the invention, a method of forming a tooth ornament base is provided. The method includes: filling a first concavity of a template with a first droplet of a clear, light-curing sealant/resin; covering the template with a clear, non-stick surface to form a flat surface at the upper portion of the first droplet; and light-curing the first droplet to solidify the first droplet and form the tooth ornament base.

In another illustrative, non-limiting embodiment of the invention, a method of forming a tooth ornament with a mold is provided. The method includes: filling a first concavity of a template with a first droplet of a clear, adhesive, light-curing sealant/resin; covering the template with a clear, non-stick surface to form a flat surface at the upper portion of the first droplet; light-curing the first droplet to solidify the first droplet and form the tooth ornament base having a second concavity; removing the tooth ornament base from the template; placing a second droplet of the clear, adhesive, light-curing sealant/resin into the second concavity; positioning a gemstone into the second droplet and the second concavity; light-curing the second droplet, after the gemstone is positioned; forming a plurality of layers of the clear, adhesive, light-curing sealant/resin on the light-cured first and second droplets and the gemstone; and light-curing each of the plurality of layers, after each of the plurality of layers is formed.

In another illustrative, non-limiting embodiment of the invention, a method of forming a tooth ornament with a decal is provided. The method includes: forming a first layer of a clear, adhesive, light-curing sealant/resin of at least the same size as the decal on a smooth, flat surface; light-curing the first layer; forming a second layer of the clear, adhesive, light-curing sealant/resin of at least the same size as the decal on the first light-cured layer; setting the decal into the second layer; light-curing the second layer; forming a third layer of the clear, adhesive, light-curing sealant/resin of at least the same size as the second layer on the decal and the second light-cured layer; and light-curing the third layer.

### BRIEF DESCRIPTION OF THE DRAWINGS

FIG. 1 shows a side view of a droplet of a clear, light-curing sealant/resin applied onto a clean, smooth surface;

FIG. 2 shows a side view of the clear, light-cured sealant/resin droplet having a triangular cone-shaped concavity drilled into the center by a triangular cone-shaped drill bit or bur;

FIG. 3 shows a side view of the clear, light-cured sealant/resin droplet with the triangular cone-shaped concavity filled with a clear, light-curing, liquid sealant/resin to adhere a gemstone into a centered position;

FIG. 4 shows a side view of the clear, light-cured sealant/resin droplet with the gemstone embedded into the triangular cone-shaped concavity being light-cured for approximately twenty seconds;

FIG. 5 shows a side view of the clear, light-cured sealant/resin with the gemstone embedded into the triangular cone-shaped concavity with a thin layer of clear, light-cured sealant/resin covering the entire structure;

FIG. 6 shows an overview of the gemstone embedded into the clear, light-cured sealant/resin;

FIG. 7 shows a side view of a template made of a soft metal, glass, plastic or any other substance with a triangular cone-shaped protrusion in the center of the concavity formed by a drill bit or bur;

FIG. 8 shows a side view of the concavity containing the protrusion filled with clear, liquid sealant/resin of a light-curing, low viscosity, non-filled formulation;

FIG. 9 shows a side view of a template filled to the top of a concavity with the clear, light-cured sealant/resin and a clear sheet of a nonstick product, such as glass or plastic, placed on top of the concavity;

FIG. 10 shows a side view of a sealant/resin mold having been removed from the template and turned 1800, making it available to accept a gemstone;

FIG. 11 shows a side view of a first layer of clear, light-curing sealant/resin on a smooth non-stick surface;

FIG. 12 shows a side view of a decal embedded into a second layer of clear, light-curing sealant/resin to be used for a live or artificial tooth ornament, formed on a first layer of clear, light-curing sealant/resin;

FIG. 13 shows a side view of a second layer of clear, light-curing sealant/resin containing a decal being coated with a third layer of clear, light-curing sealant/resin to protect the decal from damage of foreign objects striking the tooth or biting particles that could possible dislodge or damage the decal;

FIG. 14 shows a side view of a tooth ornament with a light reflective gemstone formed on a tooth.

FIG. 15 shows a side view of an embodiment of a gemstone holding tool;

FIG. 16 shows a top view of a gemstone holding tool;

FIG. 17 shows a gemstone on a gemstone holding tool with a first droplet of clear, adhesive, light-curing sealant/resin formed on the gemstone and the top of the gemstone holding tool;

FIG. 18 shows a gemstone and a light-cured first droplet of clear, adhesive light-curing sealant/resin that have been removed from a gemstone holding tool; and

FIG. 19 shows a gemstone encased in first and second droplets of clear, adhesive light-curing sealant/resin.

### DESCRIPTION OF THE ILLUSTRATIVE EMBODIMENTS OF THE INVENTION

The following description of the embodiments discloses specific configurations, features, and operations. However, the embodiments are merely examples of the present invention, and thus, the specific features described below are merely used to more easily describe such embodiments and to provide an overall understanding of the present invention.

Accordingly, one skilled in the art will readily recognize that the present invention is not limited to the specific embodiments described below. Furthermore, the descriptions of various configurations, features, and operations of the present invention that are readily grasped by one skilled in the art are omitted for the sake of clarity and brevity.

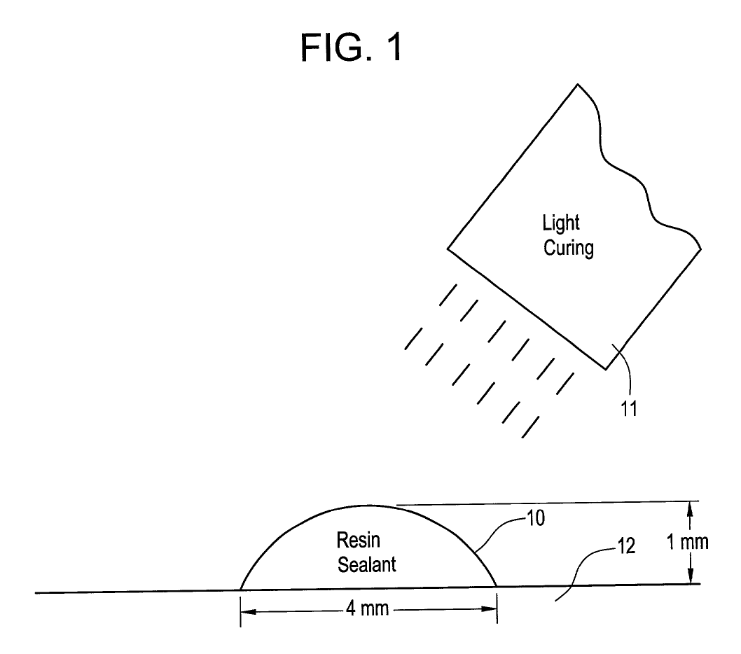

FIGS. 1-6 show the various stages in the formation of a tooth ornament according to an embodiment of the present invention.

FIG. 1 shows a side view of a first clear sealant/resin layer 10, formed from a first droplet of clear sealant/resin and applied to a clean smooth surface 12. In one implementation, the first clear sealant/resin layer 10 is formulated from an adhesive, light-curing, low viscosity, non-filled sealant/resin, which will allow a decorative portion subsequently placed in the first clear sealant/resin layer 10 to be readily visible. An example of such a sealant/resin is FORTIFY™, manufactured by BISCO, Inc. Although light-curing sealant/resin is described herein, self-curing sealant/resin can also be used.

As is known in the art of dentistry, a non-filled or unfilled sealant/resin is one which is not filled with a colored resin, normally used to match the color of the sealant/resin to the color of the tooth. Ambient light rays will be absorbed and reflected with brilliance due to the unfilled formulation of the sealant. An unfilled resin is very clear and transparent, which is especially advantageous when applying a diamond to the tooth. The transparent nature of the sealant allows for the sparkle of the gems facets to be seen from every outward angle.

The sealant/resin is used in the dental industry to seal out bacteria and seal fillings and composites, for example. The sealant/resin allows for adhesive bonding. After the sealant has been light-cured, it solidifies and forms a physical bond.

Although the sealant/resin absorbs and reflects more light rays if it is clear, colored sealant/resins may also be used.

A variety of materials can be used for the decorative portion, including, for example, one or more of the following materials: light reflective gemstones, precious and non-precious metals, and decals. Examples of light reflective gemstones include, but are not limited to, diamonds, sapphires, rubies, and zirconia. The decals are made of any substance that may be approved for use in the mouth.

As shown in FIG. 1, the first clear sealant/resin layer 10 is cured with a conventional curing light 11 equipped with a conventional coneshaped curing light enhancer (not shown) to direct the light rays to a specific area for a period of time of approximately twenty seconds. In one implementation, the dimensions of the first clear sealant/resin layer 10 for a gemstone of 0.01-0.02 ct. are about 1 mm thick and about 4 mm wide (as shown in FIG. 1), or for a gemstone of 0.03-0.04 ct. are about 2 mm thick and about 4 mm wide.

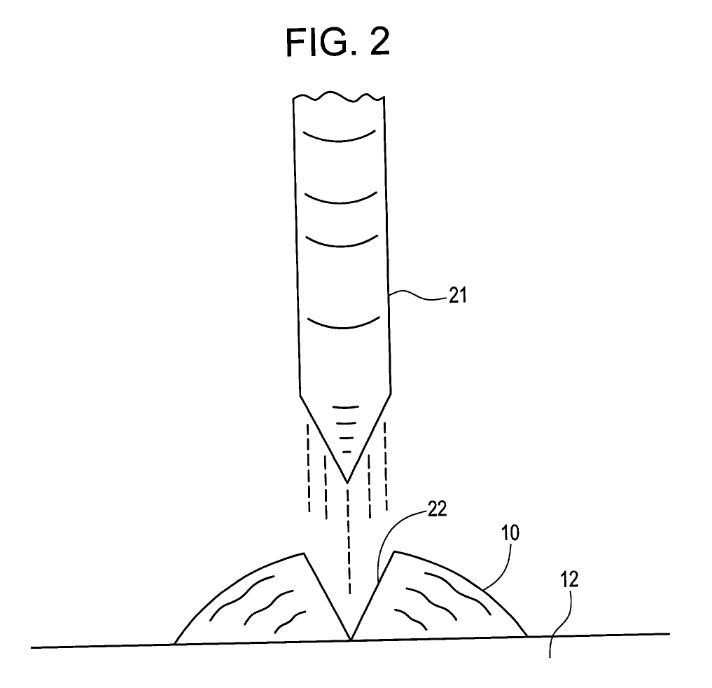

FIG. 2 shows a side view of the first light-cured clear sealant/resin layer 10 having a triangular cone-shaped concavity 22 drilled into the center by a milling tool (not shown) having a triangular cone-shaped drill bit or bur 21. The purpose of the concavity 22 is to allow for the insertion of a gemstone into the first light-cured clear sealant/resin layer 10.

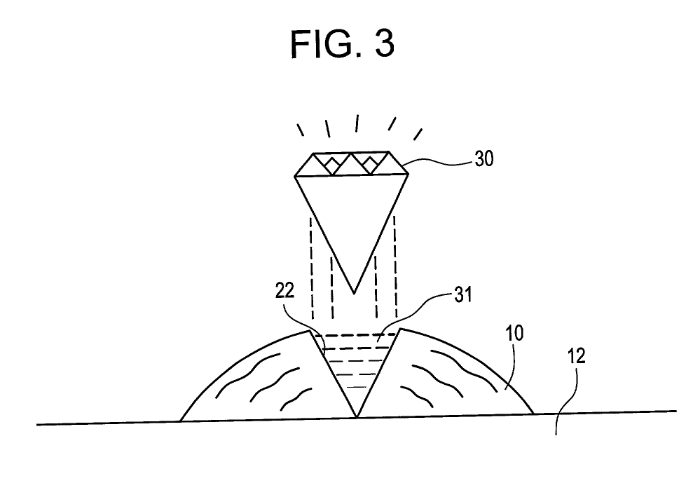

FIG. 3 shows a side view of the first light-cured clear sealant/resin layer 10 with the triangular cone-shaped concavity 22 being filled with a second clear light-curing sealant/resin layer 31, formed from a second droplet of clear sealant/resin, to adhere the gemstone 30 into a centered position of the first light-cured clear sealant/resin layer 10.

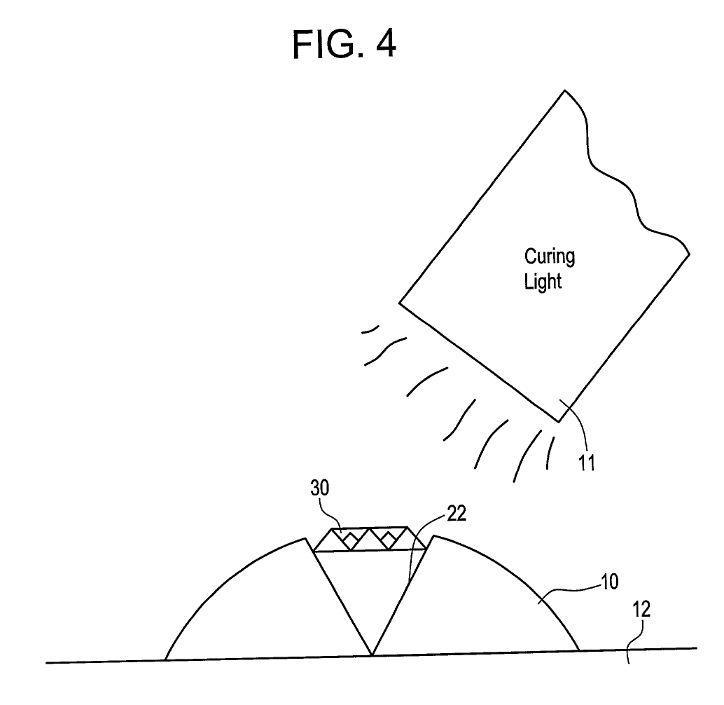

FIG. 4 shows a side view of the first light-cured clear sealant/resin layer 10 with the gemstone 30 embedded into the triangular cone-shaped concavity 22 being light-cured for approximately twenty seconds to seat the gemstone 30 into and harden the second clear sealant/resin layer 31.

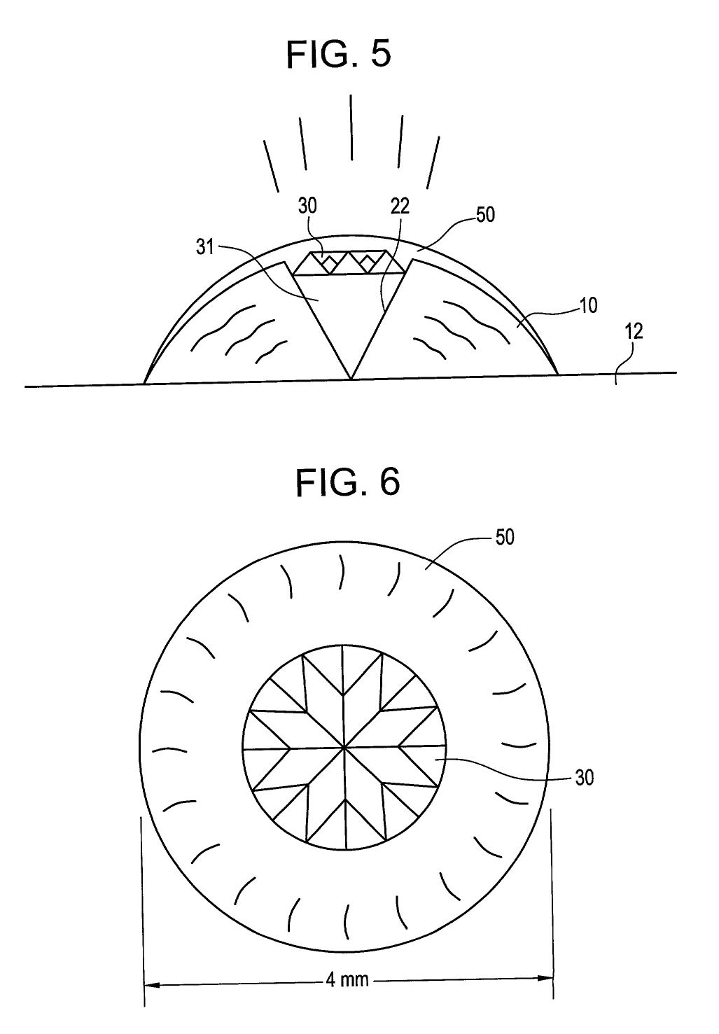

FIG. 5 shows a side view of the first and second clear, light-cured sealant/resin layers 10 and 31 with the gemstone 30 embedded into the triangular cone-shaped concavity 22 with a third clear, light-curing sealant/resin layer 50 covering the entire structure. The first, second and third clear light-cured sealant/resin layers 10, 31, and 50 are a clear sealant/resin portion, securing a decorative portion, which is shown in FIG. 5 as a gemstone 30.

After its addition to the structure, the third clear, light-curing sealant/resin layer 50 is light-cured. The third clear, light-cured sealant/resin layer 50 is added to ensure the security of the gemstone 30, so that the gemstone 30 will not readily dislodge from the first and second layers of clear, light-cured sealant/resin 10 and 31. The third light-cured clear sealant/resin layer 50 will also protect the mouth of an individual having a tooth ornament mounted on a tooth from rough edges of the gemstone 30 or the first and second layers of light-cured clear sealant/resin 10 and 31.

Instead of only a single third clear, light-curing sealant/resin layer 50 being applied to the structure, a plurality of layers can be applied with each layer being light-cured after being formed on the structure.

In one implementation, the first, second, and third clear, light-curing sealant/resin layers 10, 31, and 50 are formed of a non-toxic dental sealant resin which is a non-filled, low viscosity sealant/resin having the property of adhesiveness prior to being light-cured.

FIG. 6 shows an overview of the gemstone 30 embedded into the clear sealant/resin portion. As shown in FIG. 6, the gemstone 30 is positioned in the center of the clear sealant/resin portion.

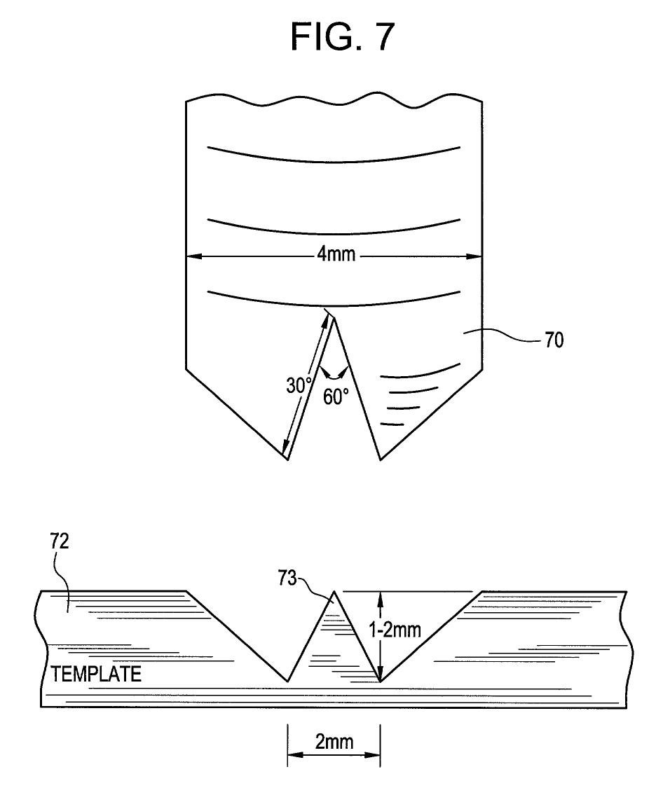

FIGS. 7-10 show the steps for forming a mold, or tooth ornament base, of a tooth ornament according to the present invention.

FIG. 7 shows a side view of a template 72 made of, for example, a soft metal, glass, or plastic with a triangular cone-shaped protrusion 73 in the center of the concavity. The template 72 is produced by using a milling tool (not shown) having a drill bit 70 or bur with a width of around 4 mm, which leaves a triangular cone-shaped protrusion 73 in the center of the concavity having approximately a 30° angle. In one implementation, the height of the protrusion 73 for a 0.01-0.02 ct. gemstone is about 1 mm, or about 2 mm for a 0.03-0.04 ct. gemstone.

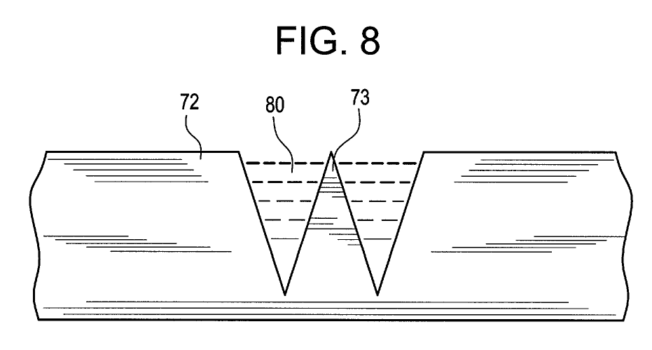

FIG. 8 shows a side view of the concavity containing the protrusion 73 of FIG. 7 filled with clear liquid sealant/resin 80 of a light-curing, low viscosity, non-filled formulation. The sealant/resin 80 is light-cured with a conventional curing light equipped with a conventional cone-shaped curing light enhancer to direct the light rays to a specific area for a period of about twenty seconds.

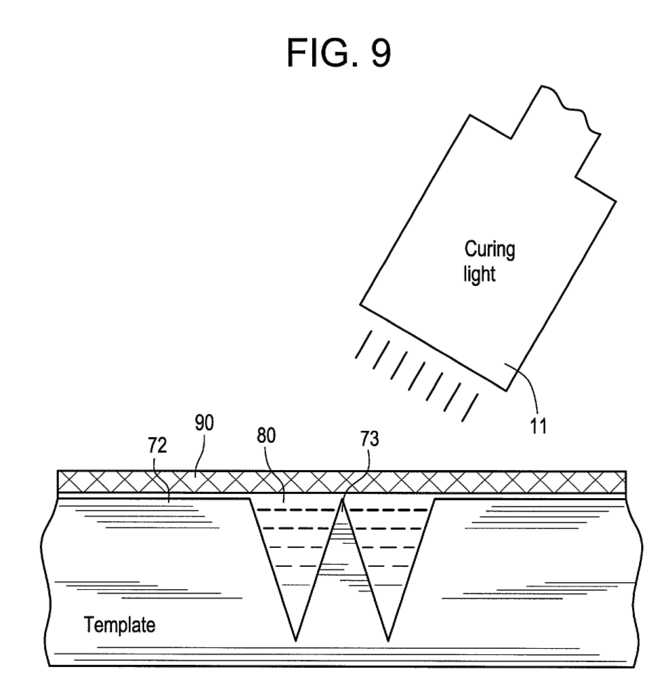

FIG. 9 shows a side view of a template 72 filled to the top of a concavity with clear light-curing sealant/resin 80 and a clear sheet of a nonstick material 90, such as glass or plastic, placed on top of the concavity. This clear sheet acts as a cover that creates the flat surface of sealant/resin that is bonded to the tooth. The sealant/resin 80 is light-cured through the transparent cover for about 30 seconds.

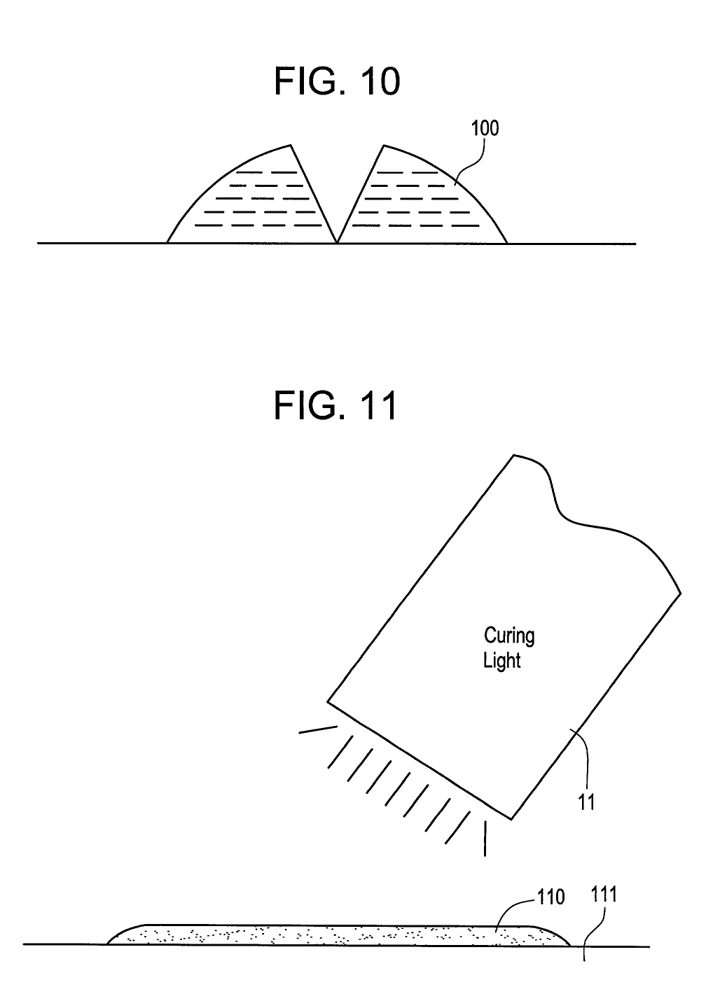

FIG. 10 shows a side view of a clear light-cured sealant/resin tooth ornament base 100 having been removed from the template and turned 180°, making it available to accept a gemstone 30. The tooth ornament base 100 of FIG. 10 could then proceed through the steps shown, for example, in FIGS. 3-5 to produce a tooth ornament, as described above.

FIGS. 11-13 show the steps involved in the formation of a tooth ornament having a decal.

FIG. 11 shows a side view of a first layer 110 of clear, adhesive, light-curing sealant/resin formed on a smooth, flat non-stick surface 111. The first layer 110 is at least as large as a decal which is positioned above the first layer 110 in a subsequent operation. After formation of the first layer 110 on the non-stick surface 111, the first layer 110 is light-cured by a curing light 11.

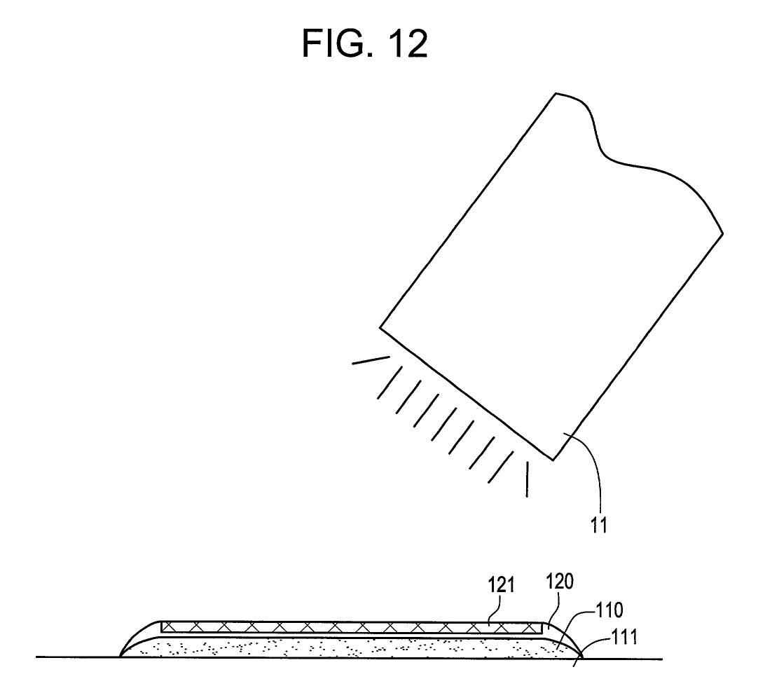

In FIG. 12, a decal 121 is embedded into a second layer 120 of clear, adhesive, light-curing sealant/resin on a clean smooth surface 111. In one implementation, the second layer 120 of clear, adhesive, light-curing sealant/resin has a low viscosity, non-filled formulation. The width of the second layer 120 is approximately 4 mm. The decal 121, made of any substance that may be approved for use in the mouth, is positioned in the second layer 120 in a central location for the viewing to be appealing to the eye. The second layer 120 containing the decal 121 is light-cured, preferably with a conventional curing light 11 equipped with a conventional cone-shaped curing light enhancer (not shown) used to direct the light rays to a specific area for a period of approximately twenty seconds.

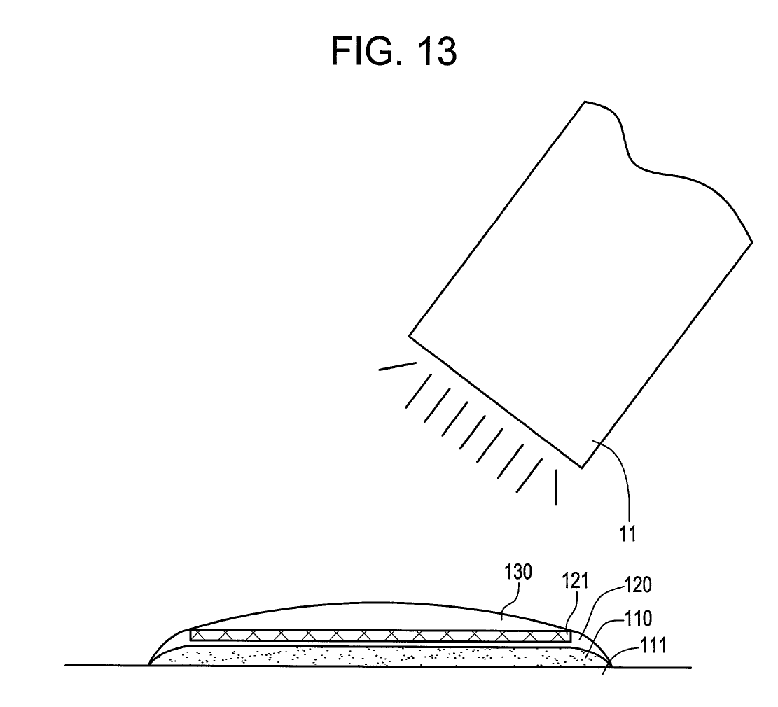

FIG. 13 shows a side view of a layer containing a decal being coated with a third layer 130 of clear, adhesive, light-curing sealant/resin to protect the decal 121 from damage from foreign objects striking the tooth or biting particles that could possibly dislodge or damage the decal. The third layer 130 protects the decal from dislodging due to wear, brushing or normal tooth hygiene. The third layer 130 is cured with a conventional curing light 11 and, preferably a cone-shaped curing light tip enhancer (not shown), which directs the light rays to a specific area.

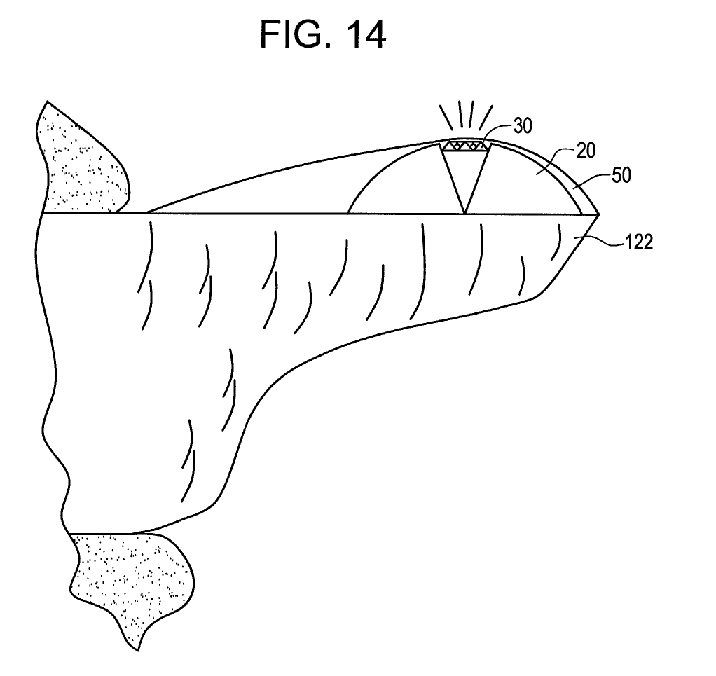

FIG. 14 shows a side view of a tooth ornament with a light reflective gemstone 30 formed on a tooth 122. As shown in FIG. 14, the tooth ornament is non-invasively and adhesively attached to the tooth 122 and sealed with a sealant/resin 50. One method of attaching the tooth ornament to the tooth 122 is by etching the tooth 122 and bonding the tooth ornament to the tooth 122 in accordance with conventional dental procedures. Bonding per se is a procedure known to those in the dental profession. The tooth is cleaned and etched, the ornament is placed on the tooth with the dental sealant, the sealant is light cured, and additional layers of sealant are brushed over the ornament to fill in any gaps around the ornament and to create a very smooth surface. Each layer is light cured individually. However, the tooth ornaments of the present invention may be attached to the tooth using other methods.

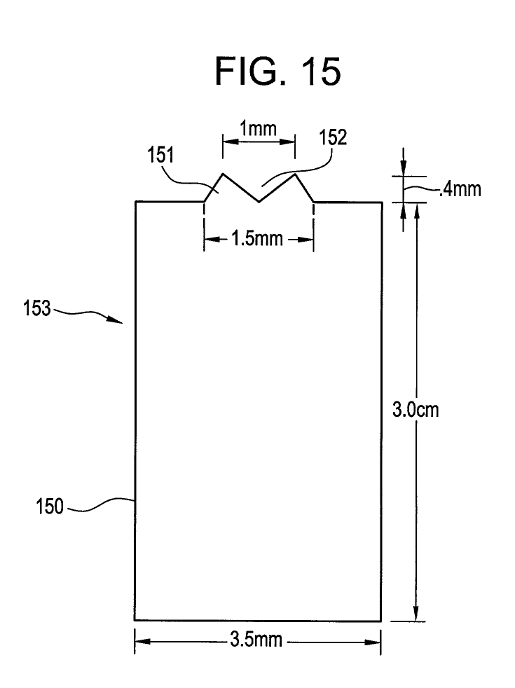

FIG. 15 shows a cross-sectional view of a tool 153 used for holding gemstones during a tooth ornament formation process. The tool 153 has a main body 150 and an ornament holding portion 151 disposed at a top surface of the main body and having a concavity 152 for holding a tooth ornament, such as a gemstone.

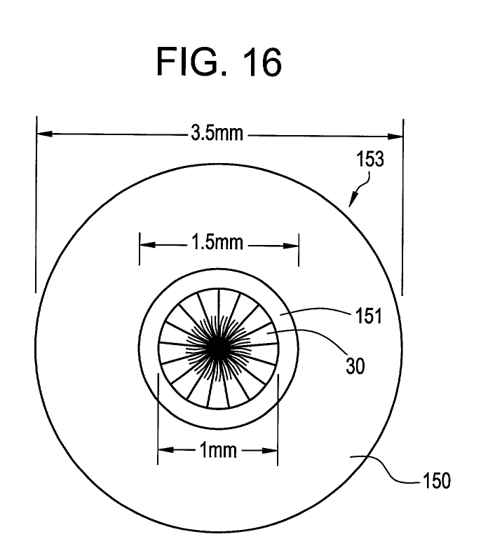

FIG. 16 shows a top view of the tool 153 with a gemstone 30 positioned in its center.

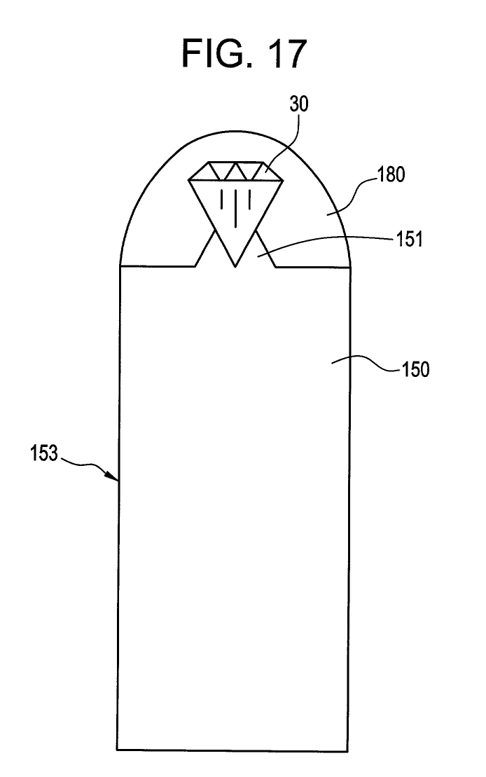

FIG. 17 shows a gemstone 30 on a tool 153 with a first droplet of clear, adhesive, light-curing sealant/resin 180 covering the gemstone 30 and the top of the tool 153. After the first droplet 180 is placed on the gemstone 30 and the top of the tool 153, the first droplet is light-cured.

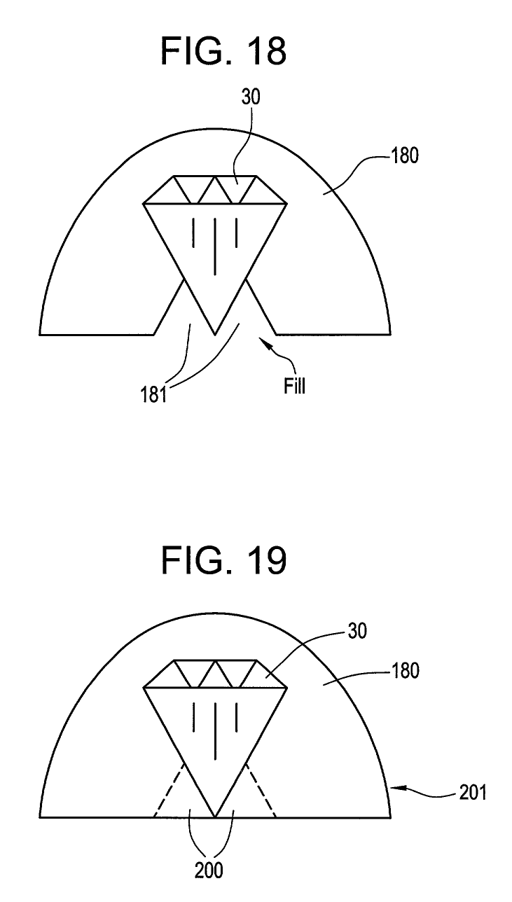

FIG. 18 shows a gemstone 30 and a light-cured first droplet of clear, adhesive light-curing sealant/resin 180 that have been removed from a gemstone holding tool. At the bottom of the gemstone 30 is an area 181 which is not covered by the first droplet of clear, adhesive light-curing sealant/resin 180. The uncovered area 181 is then covered with a second droplet of clear, adhesive light-curing sealant/resin 200, as shown in FIG. 19.

FIG. 19 shows a gemstone encased in first and second droplets of clear, adhesive light-curing sealant/resin 180 and 200. The second droplet 200 is placed in the uncovered area 181 after the gemstone 30 and the light-cured first droplet 180 have been removed from the tool 153. Then, the second droplet 200 is light cured to form a complete encasement 201 of the gemstone 30.

The same type of sealant/resin used in the tooth ornament may be used to bond the tooth ornament to the tooth. Use of the same type of sealant/resin facilitates the bond.

Although the preferred embodiments of the present invention have been described, it will be understood by those skilled in the art that the present invention should not be limited to the described preferred embodiments, but various changes and modifications can be made within the spirit and scope of the present invention as defined by the appended claims.

What is claimed is:

1. An ornament for a tooth, comprising:
a clear sealant/resin portion formed on a smooth flat surface; and
a decorative portion encased by the clear sealant/resin portion.

2. The ornament for a tooth of claim 1, wherein the decorative portion comprises a light reflective gemstone.

3. The ornament for a tooth of claim 1, wherein the decorative portion comprises precious or non-precious metal.

4. The ornament for a tooth of claim 1, wherein the decorative portion comprises a decal.

5. The ornament for a tooth of claim 1, wherein the clear sealant/resin portion is formed of a non-filled, low viscosity, light-curing adhesive sealant/resin.

6. An ornament for a tooth, comprising:
a first clear sealant/resin layer formed on a smooth flat surface and having a concavity;
a second clear sealant/resin layer in the concavity;
a decorative portion on the second clear sealant/resin layer; and
a third clear sealant/resin layer on the decorative portion and the first and second clear sealant/resin layers.

7. The ornament for a tooth of claim 6, wherein the first, second and third sealant/resin layers are formed of a non-filled, low viscosity, light-curing adhesive sealant/resin.

8. The ornament for a tooth of claim 6, wherein the decorative portion comprises a light reflective gemstone.

9. The ornament for a tooth of claim 6, wherein the decorative portion comprises precious and non-precious metal.

10. The ornament for a tooth of claim 8, wherein the karat weight of the gemstone is 0.01-0.02 ct. and the first clear sealant/resin layer is formed from a droplet of clear sealant/resin having a thickness of 1 mm and a width of no more than 4 mm.

11. The ornament for a tooth of claim 8, wherein the karat weight of the gemstone is 0.03-0.04 ct. and the first clear sealant/resin layer is formed from a droplet of clear sealant/resin having a thickness of 2 mm and a width of no more than 4 mm.

12. A method of forming a tooth ornament, comprising:
placing a first droplet of a clear, adhesive, light-curing sealant/resin on a smooth flat surface;
light-curing the first droplet;
forming a concavity in the light-cured first droplet;
placing a second droplet of the clear, adhesive, light-curing sealant/resin into the concavity;
positioning a gemstone into the second droplet and the concavity;
light-curing the second droplet, after the gemstone is positioned; and
forming and light-curing one or more layers of the clear, adhesive, light-curing sealant/resin on the light-cured first and second droplets and the gemstone.

13. The method of claim 12, wherein, when the karat weight of the gemstone is 0.01-0.02 ct., the first droplet is provided so as to have a thickness of 1 mm and a width of no more than 4 mm.

14. The method of claim 12, wherein, when the karat weight of the gemstone is 0.03-0.04 ct., the first droplet is provided so as to have a thickness of 2 mm and a width of no more than 4 mm.

15. The method of claim 12, wherein the gemstone is centered in the concavity during the positioning step.

16. The method of claim 12, wherein the clear, adhesive, light-curing sealant/resin has properties of being low viscosity and non-filled.

17. The method of claim 12, further comprising forming the concavity with a milling tool having a triangular-shaped drilling end.

18. A method of forming a tooth ornament base, comprising:
filling a first concavity of a template with a first droplet of a clear, light-curing sealant/resin;
covering the template with a clear, non-stick surface to form a flat surface at the upper portion of the first droplet; and
light-curing the first droplet to solidify the first droplet and form the tooth ornament base.

19. The method of claim 18, wherein the first concavity has a cone-shaped center portion which forms a second concavity in the tooth ornament base.

20. The method of claim 19, wherein the width of the tooth ornament base is no more than 4 mm.

21. The method of claim 18, further comprising:
drilling the template with a drill bit having an inverted conical shape at the center thereof to form the first concavity.

22. The method of claim 18, wherein the clear, light-curing sealant/resin has properties of being low viscosity and non-filled.

23. A method of forming a tooth ornament with a mold, comprising:
filling a first concavity of a template with a first droplet of a clear, adhesive, light-curing sealant/resin;
covering the template with a clear, non-stick surface to form a flat surface at the upper portion of the first droplet;
light-curing the first droplet to solidify the first droplet and form the tooth ornament base having a second concavity;
removing the tooth ornament base from the template;
placing a second droplet of the clear, adhesive, light-curing sealant/resin into the second concavity;
positioning a gemstone into the second droplet and the second concavity;
light-curing the second droplet, after the gemstone is positioned;
forming a plurality of layers of the clear, adhesive, light-curing sealant/resin on the light-cured first and second droplets and the gemstone; and
light-curing each of the plurality of layers, after each of the plurality of layers is formed.

24. The method of claim 23, wherein the clear, adhesive, light-curing sealant/resin has properties of being low viscosity and non-filled.

25. A method of forming a tooth ornament with a decal, comprising:
forming a first layer of a clear, adhesive, light-curing sealant/resin of at least the same size as the decal on a smooth, flat surface;
light-curing the first layer;
forming a second layer of the clear, adhesive, light-curing sealant/resin of at least the same size as the decal on the first light-cured layer;
setting the decal into the second layer;
light-curing the second layer;
forming a third layer of the clear, adhesive, light-curing sealant/resin of at least the same size as the second layer on the decal and the second light-cured layer; and
light-curing the third layer.

26. A tool for forming an ornamental tooth decoration, comprising:
a main body;
an ornament holding portion disposed at a top surface of the main body and having a concavity for holding a tooth ornament.

27. The tool of claim 26, wherein the concavity has an outer diameter of about 1.5 mm and an inner diameter of about 1 mm for holding the tooth ornament, and
wherein the tooth ornament is a gemstone having a carat weight of about 0.01-0.04 ct.

28. A method of forming an ornamental tooth decoration, comprising:
positioning a gemstone in a concavity of a gemstone holding tool;
covering an upper portion of the gemstone and an upper portion of the gemstone holding tool with a first droplet of a clear, adhesive, light-curing sealant/resin;
light-curing the first droplet of clear, adhesive, light-curing sealant/resin;
removing the gemstone and the light cured first droplet from the gemstone holding tool;
covering a lower portion of the gemstone with a second droplet of clear, adhesive, light-curing sealant/resin, such that the gemstone is encased by the clear, adhesive, light-curing sealant/resin; and
light-curing the second droplet of clear, adhesive, light-curing sealant/resin.
